(19) United States
(12) Patent Application Publication
(10) Pub. No.: US 2024/0272888 A1
(43) Pub. Date: Aug. 15, 2024

(54) RESOLVING DEPENDENCY GRAPHS WITH CYCLES IN PARALLEL

(71) Applicant: SAP SE, Walldorf (DE)

(72) Inventor: Joerg Weisbarth, Bruchsal (DE)

(21) Appl. No.: 18/169,364

(22) Filed: Feb. 15, 2023

(51) Int. Cl. G06F 8/61

(52) U.S. Cl. CPC G06F 8/61

(57) ABSTRACT

In an implementation, a computer-implemented method includes, in each iteration: determining whether there exists one still unevaluated action in a dependency graph. A set of still unevaluated actions without any unevaluated required dependencies is determined. An evaluation for each action in the set of still unevaluated actions is asynchronously started, where evaluations execute in parallel without waiting on evaluation of other actions. Until at least one ongoing action evaluation has finished, waiting. All still uncollected results of finished asynchronous evaluations are collected.

### BACKGROUND

Deployments may offer services to users of a software product in a cloud-computing landscape. To work properly, each deployment may reply (among other things) on a key-value structure (context) and provide a key-value structure (export) for other deployments. A deployment can, either, obligatorily or optionally, depend on exports of other deployments and receive exports as part of its own context.

Required dependencies in a cloud-computing landscape must be cycle-free, while all dependencies together may introduce cycles. As a consequence, evaluation of a deployment's export may affect already-evaluated exports of other deployments and happen recursively until exports cease changing due to re-evaluation(s).

Despite the capabilities of modern central processing units (CPUs), due to a large number of deployments and associated dependencies in cloud-computing landscapes, context-and export-evaluation for a deployment may take an extended period of time (for example, several minutes. Users typically perceive the time delay as poor system performance.

### SUMMARY

The present disclosure describes resolving dependency graphs with cycles in parallel.

In an implementation, a computer-implemented method, comprising: in each iteration: determining whether there exists one still unevaluated action in a dependency graph; determining a set of still unevaluated actions without any unevaluated required dependencies; asynchronously starting an evaluation for each action in the set of still unevaluated actions, wherein evaluations execute in parallel without waiting on evaluation of other actions; waiting until at least one ongoing action evaluation has finished; and collecting all still uncollected results of finished asynchronous evaluations.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, the described approach can mitigate perceived deployment time delays and reduce user perception of poor system performance. Second, the described approach can make deployments into a cloud-computing landscape more efficient and reduce deployment time. Third, the ability to work with cyclic dependency graphs enhances the overall deployment process with greater flexibility.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is an illustration of a dependency graph, according to an implementation of the present disclosure.

FIG. 2A is a flowchart illustrating an example of a computer-implemented method representing a Phase 1 for resolving dependency graphs with cycles in parallel, according to an implementation of the present disclosure.

FIG. 2B is a flowchart illustrating an example of a computer-implemented method representing a Phase 2 for resolving dependency graphs with cycles in parallel, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes resolving dependency graphs with cycles in parallel, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Deployments may offer services to users of a software product in a cloud-computing landscape. To work properly, each deployment may reply (among other things) on a key-value structure (context) and provide a key-value structure (export) for other deployments. A deployment can, either, obligatorily (that is, require) or optionally, depend on exports of other deployments and receive exports as part of its own context.

Required dependencies in a cloud-computing landscape must be cycle-free, while all dependencies together may introduce cycles. As a consequence, evaluation of a deployment's export may affect already-evaluated exports of other deployments and happen recursively until exports cease changing due to re-evaluation(s).

Despite the capabilities of modern central processing units (CPUs), due to a large number of deployments and associated dependencies in cloud-computing landscapes, context-and export-evaluation for a deployment may take an extended period of time (for example, several minutes. Users typically perceive the time delay as poor system performance.

This disclosure describes an approach to mitigate the perception of poor system performance by more efficiently managing context-and export-evaluations for deployments. In the described approach dependency-graphs with cycles are resolved in parallel.

For the purposes of this disclosure, a dependency of a deployment “d1” towards another one “d2” is considered to be resolved if the export of “d2” has already been evaluated. Deployment dependency is considered to be changed if a particular export it depends on has changed since a last evaluation of its context and export.

At a high-level, a dependency graph is a data structure that is formed by a directed graph describing the dependencies of an entity in a system on other entities of the same system. In the directed graph of a dependency graph, each node points to the node(s) on which it depends.

Dependency-graphs are used to perform actions where each entity produces some result (such as, an “export”) that other entities may depend on in a particular order. Common examples can include installers for software-packages, software build-tools, spreadsheet calculators, and service management of infrastructural services within a cloud where one service may depend on another service to be available. Typically, dependency-graphs are required to be acyclic (that is, free of cycles), which makes it easy to resolve.

The described approach performs dependency-resolution making use of parallelization and other optimizations. It is applicable to both, acyclic and (the more general) cyclic dependency-graphs.

In more detail, a dependency graph consists of a set of nodes (“vertexes”) V and a set of edges E⊆V×V (for example, represented by arrows), which represent dependencies between the nodes. For each e=(v1, v2)∈E we say, v1 depends on v2 or—reversely—v2 is a dependency of v1. In pure mathematics, a single vertex may be a function. However, in the described approach, a single vertex corresponds to an action that may require inputs and-given those inputs-produces some output. The inputs are the outputs of other vertexes the single vertex depends on.

Evaluating an action means to provide the action its needed inputs and producing an output. As with mathematical functions, an evaluation must be right-unique (that is, the same input always produces the same output). To evaluate an entire dependency-graph means to evaluate all the actions (potentially involving parallel evaluation of several actions at once).

Acyclic dependency-graphs possess no circular dependencies. If, and only if, this is the case, then there exists at least one topological order of evaluation for the actions. Such an order ensures that if the actions are run according to the order, each action receives all necessary dependency inputs that are provided from other actions.

In the case of cyclic dependencies, the described approach extends the definition of a dependency-graph. Instead of having only one set of edges, there are two, Er⊆V×V and Eo⊆V×V. For each e=(v1 , v2)Er, v1 depends requisitely on v2 or—reversely—v2 is a required dependency ∈of v1. For each e=(v1 , v2)∈Eo, v1 depends optionally on v2 or—reversely—v2 is an optional dependency of v1.

To evaluate an action, only required dependencies are necessary and any combination of optional dependencies may be additionally provided. In the described approach, the set Er must be acyclic, but there are no restrictions on the set Eo.

The definition of an evaluation of the entire dependency graph is more complicated compared to a traditional dependency graph, where each action is required to be evaluated. The reason is that the extended definition of a dependency-permits providing changing inputs to an action (for example, an action may be run once only with required inputs and afterwards additionally with all optional inputs). The output may differ in both cases. In contrast to a traditional dependency-graph, there is only one evaluation per action needed. This is because immediately all inputs are required and right-uniqueness enforces that further evaluations must not change the produced output.

Given an extended dependency-graph G=(V, Er, Eo), evaluating the entire dependency-graph means to evaluate all actions until each action receives:
1) All requisite dependencies and
2) All optional dependencies and their inputs remain stable (that is, evaluating their dependencies (transitively) leads to identical inputs).
   The latter is equivalent to reach stable outputs due to the demanded right-uniqueness of actions.

Unlike with traditional dependency-graphs, it is not a certainty that such an evaluation exists. It may be that changed outputs always lead (transitively) to changed inputs on a new evaluation of the same action (translated to mathematical functions, this would mean that they are injective). The simplest example would be a graph consisting of only one node that depends optionally on itself. Given no input, it produces the output 1. Given any natural number x, it produces the output x+1. The input to the next evaluation of the node would never remain stable, so an evaluation for the entire dependency-graph is incomputable.

In detail, the described approach: 1) parallelization of context-and export-evaluation so that, at any point in time during each one of two phases, a number of parallel context-and-export-evaluations reaches a theoretical maximum (note that the approach permits setting an upper bound to the degree of parallelism as it does not make sense to have significantly more evaluations in progress than, for example, available central processing unit (CPU) cores); 2) during evaluation, a case of (forever) unstable inputs is detected and the evaluation aborted; 3) reduction of a number of necessary disk Input/Output (IO) operations by moving files to a file-system in a computer system's shared memory (for example, RAM).

The approach is split into two phases. The first phase (initial evaluation) is concerned with getting to an initial evaluation of each action. The second phase (stabilization) is concerned with providing all dependencies to each action and to reach stability.

### First Phase (Initial Evaluation)

In the first phase, the described approach resolves all required dependencies by iteratively performing the following until each action has been evaluated at least once. The required dependencies are resolved in such a way that no evaluation is started without satisfied required dependencies. In some implementations, in each iteration:
1) Actions that have not yet been evaluated—in spite of all their required dependencies have been so—are determined;
2) for each of the determined actions, the approach asynchronously starts its evaluation without waiting; and
3) Results of recently completed asynchronous evaluations are collected.

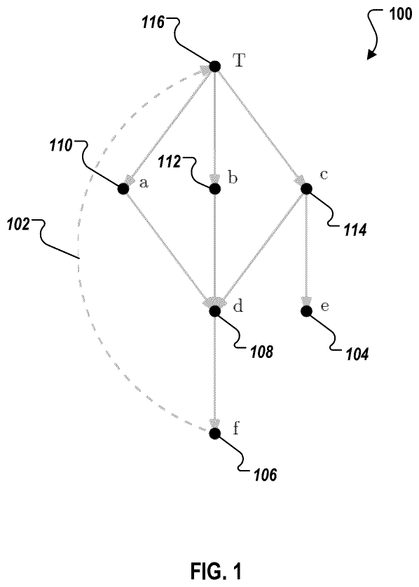

FIG. 1 is an illustration of a dependency graph 100, according to an implementation of the present disclosure.

In an example of phase 1, assume a dependency-graph 100 with the actions V={a, b, c , d, e, f, T}, the requisite dependencies Er={(T, a), (T, b), (T, c), (a, d), (b, d), (c, d), (c, e), (d, f)} and optional dependencies (refer to 102 dashed arrow) Eo={(f, T)}. Assume that each action evaluation takes the same length of time, except for action e 104, which takes twice the length of time.

In a first step of a first iteration, two actions and e 104 and f 106 are selected, because both actions have no required inputs.

After evaluation of actions and e 104 and f 106 starts, as nothing is ready, step 3 in the iteration is skipped.

At the beginning of the second iteration, consider that the action f 106 is ready, but action e 104 is still in execution and action d 108 is selected.

At the beginning of the third iteration, actions d 104, e 106, and f 108 are evaluated and actions a 110, b 112, and c 114 can be selected for evaluation.

In the last iteration, only action T 116 remains.

At the end of the first phase, each action has produced its output exactly once. In the illustrated example, optional dependencies did not play any role. However the described approach on the initial evaluation already passes to each action all optional dependencies as well as if they have been already evaluated on evaluation-start.

### Second Phase (Stabilization)

The second phase, repetitively in each iteration, asynchronously re-evaluates each action with changed inputs since a last iteration until all outputs remain stable. Initially, for the first iteration in this phase, all outputs are considered to have changed. In some implementations, a cycle-detection is introduced: a reasonable upper bound for the number of iterations is considered to be the number of actions. Further reasoning for this number follows within the disclosure. When that upper bound is exceeded, the whole process is aborted. In the case of the dependency graph 100, there are seven different actions leading to an upper bound of seven for the number of iterations.

The example for the first phase is continued by referring to FIG. 1. It is assumed that each evaluation now takes the same amount of time, including action e 104.

All actions are considered to be triggered simultaneously. Each action receives exactly the same input as in phase 1, except action f 106. This is because f 106 now gets the output of T116 which has not been calculated prior to f 106′s evaluation in Phase 1. As each action is demanded to produce—given the same input—the same output, only action f 106 may now produce a changed result.

In a next iteration, only actions that depend on action f 106 (that is, only action d 108) are evaluated. If action d 108 produces the same output as before, the stabilization is complete and phase 2 considered finished. In general, demanding from actions to be right-unique ensures that given one iteration is stable (no changes of any inputs/outputs), the next iteration would be as well.

It should be noted that another possible continuation after the first run would be an endless-cycle. For example, if the cycle f 106→d 108→b 112→T 116→f 106 always evaluates to different outputs. Only cycles may prevent stabilization from succeeding. If there are cycles in the dependency-graph that prevent stabilization, the smallest possible cycle contains at most each action exactly once. Consequently, the number of vertexes serves as an upper bound on the number of iterations we may expect. If the evaluation approach runs into a non-stabilizable situation, the number of iterations will definitely exceed that upper bound.

Another reason for the choice of choosing the number of vertexes as an upper bound is: Let the diameter (d) of the dependency graph be the maximum distance (counted in edges) between any two vertices. Let v denote the number of vertexes. Assuming there was a (arbitrary) change of an (arbitrary) output in the first iteration of the second phase compared to the evaluation of the first phase, it takes at most □iterations until the effects of this change have been propagated through the whole dependency-graph. The upper bound on for any dependency-graph is , v−1 which adds up to v with the first evaluation in the second phase. Choosing d itself as upper bound is also a reasonable choice and may be slightly more optimal in some cases.

It should also be noted that, although this approach detects each non stabilizable situation, it may nevertheless wrongly classify some situations as non-stabilizable, which in fact would lead to a stable evaluation. A simple example could be a dependency-graph with one vertex and an optional self-dependency, where the action counts down a natural number until it is 1. However detecting arbitrary non-stabilizable situations requires solving the halting problem, which is provably unsolvable. The approach of using an upper bound as described above, is a practical compromise.

A two-phase approach is described to resolve an extended dependency graph with cycles in parallel.

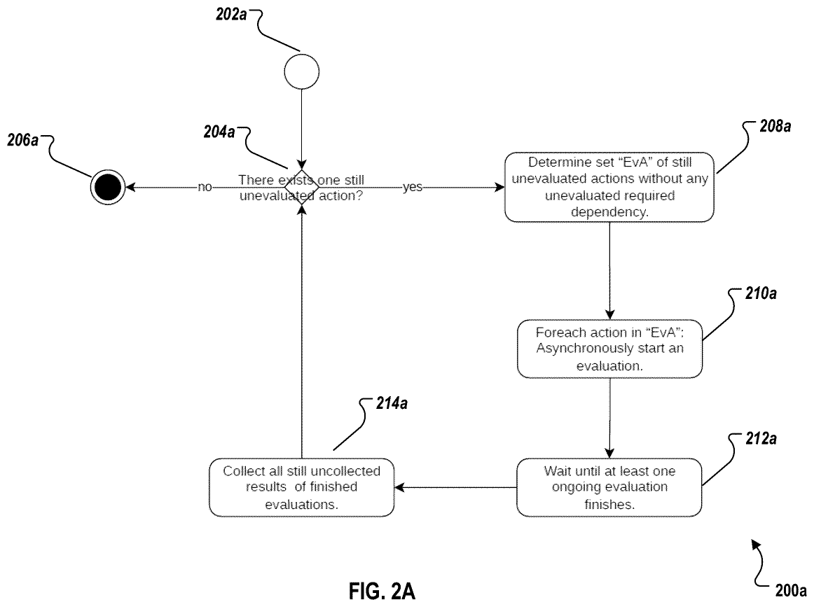

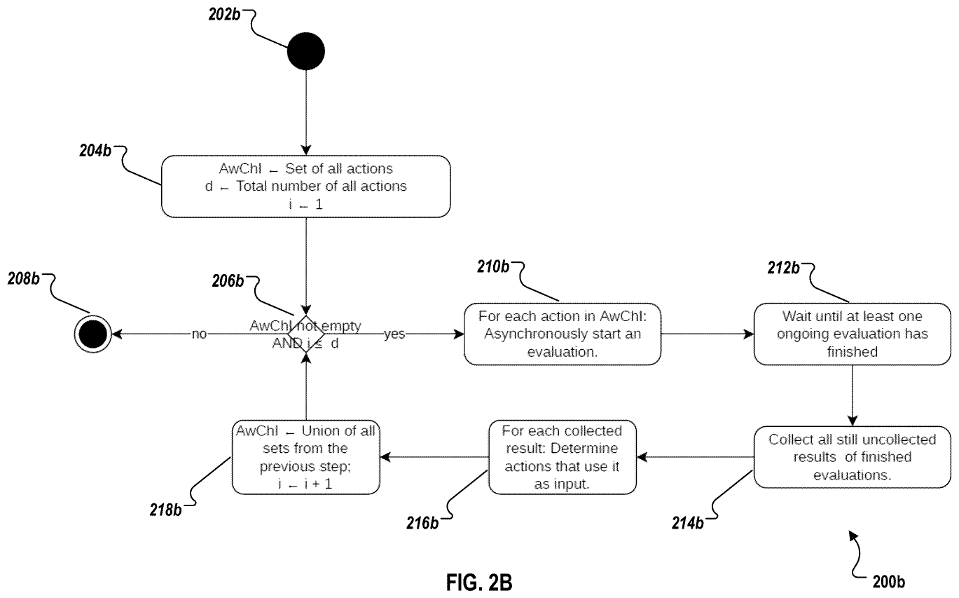

FIG. 2A is a flowchart illustrating an example of a computer-implemented method 200a representing a Phase 1 for resolving dependency graphs with cycles in parallel, according to an implementation of the present disclosure. For clarity of presentation, the description that follows generally describes method 200a in the context of the other figures in this description. However, it will be understood that method 200a can be performed, for example, by any system, environment, software, and hardware, or a combination of systems, environments, software, and hardware, as appropriate. In some implementations, various steps of method 200a can be run in parallel, in combination, in loops, or in any order.

### Phase 1 (Initial Evaluation)

Before an evaluation of an action can start, all required dependencies for the action are satisfied (resolved) by iteratively performing each action (until each action in dependency graph is evaluated at least once).

In each Phase I iteration:

At 202a, Phase 1 (method 200a) starts. From 202a, method 200a proceeds to 204a.

At 204a, a determination is made as to whether there exists one still unevaluated action in a dependency graph, even if all required dependencies have been evaluated. If it is determined that no unevaluated action exists, method 200a proceeds to 206a, where Phase 1 can exit. Otherwise, if it is determined that one still unevaluated action exists, method 200a proceeds to 208a.

At 208a, a set (for example, set “EvA”) is determined of still unevaluated actions without any unevaluated required dependencies. From 208a, method 200a proceeds to 210a.

At 210a, for each action in the set, an evaluation is started asynchronously. The evaluations all run in parallel with a main-control-flow, which directly proceeds without any waiting. From 210, method 200a proceeds to 212a.

At 212a, method 200a waits until at least one ongoing action evaluation has finished. From 212a, method 200a proceeds to 214a.

At 214a, all still uncollected results of finished asynchronous evaluations are collected. From 214a, method 200a returns to 204a.

FIG. 2B is a flowchart illustrating an example of a computer-implemented method 200b representing a Phase 2 for resolving dependency graphs with cycles in parallel, according to an implementation of the present disclosure. For clarity of presentation, the description that follows generally describes method 200b in the context of the other figures in this description. However, it will be understood that method 200b can be performed, for example, by any system, environment, software, and hardware, or a combination of systems, environments, software, and hardware, as appropriate. In some implementations, various steps of method 200b can be run in parallel, in combination, in loops, or in any order.

### Phase 2 (Stabilization)

Re-evaluate all actions with changed inputs since the last iteration until no action with changed inputs is left or an upper bound on a number of iterations is exceeded. Input for each action are the outputs of one evaluation per action it depends on. For the first iteration in this phase, all outputs are considered to have changed. The result is a stabilized set of outputs. Repetitively, and in each iteration:

At 202b, Phase II (method 200b) starts. For example, following completion of previously described Phase I. From 202b, method 200b proceeds to 204b.

At 204b, let “AwChI” denote the set of actions with changed inputs (since the last iteration). AwChI is initialized with the set of all actions, d is the total amount of actions, and i=1. Note that “AwChI” contains in each iteration (exactly) all actions that may produce a changed output on the next iteration. Additionally note that a cycle-detection is introduced: a reasonable upper bound for the number of iterations i is considered to be the number of actions d. If this upper bound is exceeded, the Phase 2 process exits. From 204b, method 200b proceeds to 206b.

At 206b, a determination is made as to whether the set “AwChI” is not empty AND i<d. If either condition is FALSE, method 200b proceeds to 208b, where Phase 2 can end. Otherwise, if both conditions are TRUE, method 200b proceeds to 210b.

At 210b, for each action in the set “AwChI”, asynchronously evaluate in parallel the action. From 210b, method 200b proceeds to 212b.

At 212b, method 200b waits until at least one ongoing action evaluation has finished. From 212b, method 200b proceeds to 214b.

At 214b, all still uncollected results of finished asynchronous evaluations are collected. From 214b, method 200b proceeds to 216b.

At 216b, for each collected result, determine a set of actions in the set of all actions that use the collected result as input.

At 216b, perform a UNION of all sets of actions that use the collected results as input with the set of all actions. Increment i=i+1. From 216b, method 200b returns to 206b.

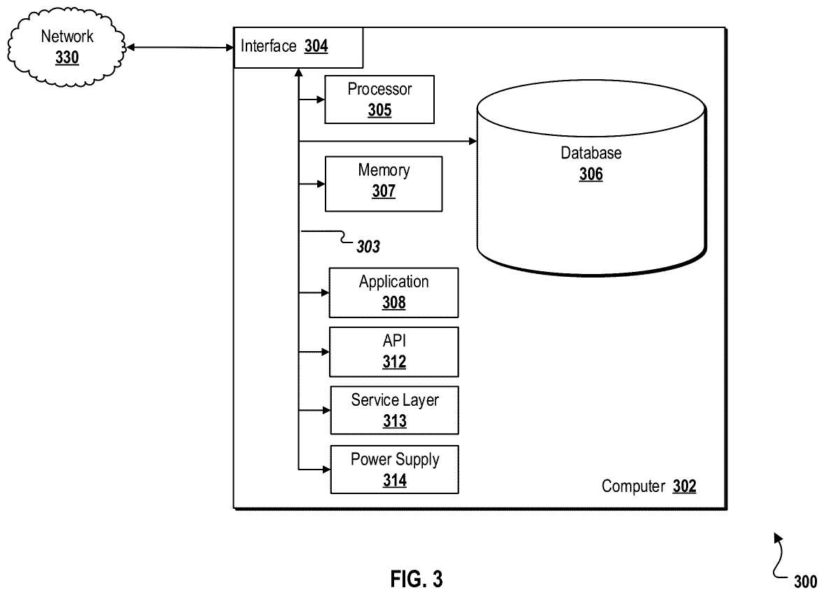

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, System 300 includes a Computer 302 and a Network 330.

The illustrated Computer 302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 302 can include an input device, such as a keypad, keyboard, or touch screen, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as, for example, a client, network component, a server, or a database or another persistency, or a combination of roles for performing the subject matter described in the present disclosure. The illustrated Computer 302 is communicably coupled with a Network 330. In some implementations, one or more components of the Computer 302 can be configured to operate within an environment, or a combination of environments, including cloud-computing, local, or global.

At a high level, the Computer 302 is an electronic computing device operable to receive, transmit, process, store, or manage data and information associated with the described subject matter. According to some implementations, the Computer 302 can also include or be communicably coupled with a server, such as an application server, e-mail server, web server, caching server, or streaming data server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory or conventional database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the

Computer 302, in alternative implementations, Database 306 can be external to the Computer 302. As illustrated, in some implementations, the Database 306 can hold one or more data types either previously described or consistent with this disclosure and the described concepts.

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple

Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user-or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

Described implementations of the subject matter can include one or more features, alone or in combination.

For example, in a first implementation, a computer-implemented method, comprising: in each iteration: determining whether there exists one still unevaluated action in a dependency graph; determining a set of still unevaluated actions without any unevaluated required dependencies; asynchronously starting an evaluation for each action in the set of still unevaluated actions, wherein evaluations execute in parallel without waiting on evaluation of other actions; waiting until at least one ongoing action evaluation has finished; and collecting all still uncollected results of finished asynchronous evaluations.

The foregoing and other described implementations can each, optionally, include one or more of the following features:

A first feature, combinable with any of the following features, comprising exiting if no still unevaluated actions exist.

A second feature, combinable with any of the previous or following features, comprising: while a set of actions with changed inputs since a last iteration (AwChI)) is not empty and the number of iterations (i) is<=the diameter (d) of the dependency graph: for each action in the AwChI: asynchronously and in parallel evaluate each action; and wait until at least one action evaluation has finished.

A third feature, combinable with any of the previous or following features, comprising: exiting if the AwChI is empty or i>d.

A fourth feature, combinable with any of the previous or following features, comprising: collecting, as collected results, all still uncollected results of finished action evaluations.

A fifth feature, combinable with any of the previous or following features, comprising: determining, for each result of the collected results, a set of actions in the set of all actions that use the result as an input.

A sixth feature, combinable with any of the previous or following features, comprising: performing a UNION of all sets of actions that use the collected results as input with the set of all actions; and increment i by 1.

In a second implementation, a non-transitory, computer-readable medium storing one or more instructions executable by a computer system to perform operations, comprising: in each iteration: determining whether there exists one still unevaluated action in a dependency graph; determining a set of still unevaluated actions without any unevaluated required dependencies; asynchronously starting an evaluation for each action in the set of still unevaluated actions, wherein evaluations execute in parallel without waiting on evaluation of other actions; waiting until at least one ongoing action evaluation has finished; and collecting all still uncollected results of finished asynchronous evaluations.

The foregoing and other described implementations can each, optionally, include one or more of the following features:

A first feature, combinable with any of the following features, comprising exiting if no still unevaluated actions exist.

A second feature, combinable with any of the previous or following features, comprising: while a set of actions with changed inputs since a last iteration (AwChI)) is not empty and the number of iterations (i) is<=the diameter (d) of the dependency graph: for each action in the AwChI: asynchronously and in parallel evaluate each action; and wait until at least one action evaluation has finished.

A third feature, combinable with any of the previous or following features, comprising: exiting if the AwChI is empty or i>d.

A fourth feature, combinable with any of the previous or following features, comprising: collecting, as collected results, all still uncollected results of finished action evaluations.

A fifth feature, combinable with any of the previous or following features, comprising: determining, for each result of the collected results, a set of actions in the set of all actions that use the result as an input.

A sixth feature, combinable with any of the previous or following features, comprising: performing a UNION of all sets of actions that use the collected results as input with the set of all actions; and increment i by 1.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: in each iteration: determining whether there exists one still unevaluated action in a dependency graph; determining a set of still unevaluated actions without any unevaluated required dependencies; asynchronously starting an evaluation for each action in the set of still unevaluated actions, wherein evaluations execute in parallel without waiting on evaluation of other actions; waiting until at least one ongoing action evaluation has finished; and collecting all still uncollected results of finished asynchronous evaluations.

The foregoing and other described implementations can each, optionally, include one or more of the following features:

A first feature, combinable with any of the following features, comprising exiting if no still unevaluated actions exist.

A second feature, combinable with any of the previous or following features, comprising: while a set of actions with changed inputs since a last iteration (AwChI)) is not empty and the number of iterations (i) is<=the diameter (d) of the dependency graph: for each action in the AwChI: asynchronously and in parallel evaluate each action; and wait until at least one action evaluation has finished.

A third feature, combinable with any of the previous or following features, comprising: exiting if the AwChI is empty or i>d.

A fourth feature, combinable with any of the previous or following features, comprising: collecting, as collected results, all still uncollected results of finished action evaluations.

A fifth feature, combinable with any of the previous or following features, comprising: determining, for each result of the collected results, a set of actions in the set of all actions that use the result as an input.

A sixth feature, combinable with any of the previous or following features, comprising: performing a UNION of all sets of actions that use the collected results as input with the set of all actions; and increment i by 1.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
in each iteration:
determining whether there exists one still unevaluated action in a dependency graph;
determining a set of still unevaluated actions without any unevaluated required dependencies;
asynchronously starting an evaluation for each action in the set of still unevaluated actions, wherein evaluations execute in parallel without waiting on evaluation of other actions;
waiting until at least one ongoing action evaluation has finished; and
collecting all still uncollected results of finished asynchronous evaluations.

2. The computer-implemented method of claim 1, comprising exiting if no still unevaluated actions exist.

3. The computer-implemented method of claim 2, comprising:
while a set of actions with changed inputs since a last iteration (AwChI)) is not empty and the number of iterations (i) is<=the diameter (d) of the dependency graph:
for each action in the AwChI:
asynchronously and in parallel evaluate each action; and
wait until at least one action evaluation has finished.

4. The computer-implemented method of claim 3, comprising:
exiting if the AwChI is empty or i>d.

5. The computer-implemented method of claim 4, comprising:
collecting, as collected results, all still uncollected results of finished action evaluations.

6. The computer-implemented method of claim 5, comprising:
determining, for each result of the collected results, a set of actions in the set of all actions that use the result as an input.

7. The computer-implemented method of claim 6, comprising:
performing a UNION of all sets of actions that use the collected results as input with the set of all actions; and
increment i by 1.

8. A non-transitory, computer-readable medium storing one or more instructions executable by a computer system to perform operations, comprising:
in each iteration:
determining whether there exists one still unevaluated action in a dependency graph;
determining a set of still unevaluated actions without any unevaluated required dependencies;
asynchronously starting an evaluation for each action in the set of still unevaluated actions, wherein evaluations execute in parallel without waiting on evaluation of other actions;
waiting until at least one ongoing action evaluation has finished; and
collecting all still uncollected results of finished asynchronous evaluations.

9. The non-transitory, computer-readable medium of claim 8, comprising exiting if no still unevaluated actions exist.

10. The non-transitory, computer-readable medium of claim 9, comprising:
while a set of actions with changed inputs since a last iteration (AwChI)) is not empty and the number of iterations (i) is<=the diameter (d) of the dependency graph:
for each action in the AwChI:
asynchronously and in parallel evaluate each action; and
wait until at least one action evaluation has finished.

11. The non-transitory, computer-readable medium of claim 10, comprising:
exiting if the AwChI is empty or i>d.

12. The non-transitory, computer-readable medium of claim 11, comprising:
collecting, as collected results, all still uncollected results of finished action evaluations.

13. The non-transitory, computer-readable medium of claim 12, comprising:
determining, for each result of the collected results, a set of actions in the set of all actions that use the result as an input.

14. The non-transitory, computer-readable medium of claim 13, comprising:
performing a UNION of all sets of actions that use the collected results as input with the set of all actions; and
increment i by 1.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
in each iteration:
determining whether there exists one still unevaluated action in a dependency graph;
determining a set of still unevaluated actions without any unevaluated required dependencies;
asynchronously starting an evaluation for each action in the set of still unevaluated actions, wherein evaluations execute in parallel without waiting on evaluation of other actions;
waiting until at least one ongoing action evaluation has finished; and
collecting all still uncollected results of finished asynchronous evaluations.

16. The computer-implemented system of claim 15, comprising exiting if no still unevaluated actions exist.

17. The computer-implemented system of claim 16, comprising:
while a set of actions with changed inputs since a last iteration (AwChI)) is not empty and the number of iterations (i) is<=the diameter (d) of the dependency graph:
for each action in the AwChI:
asynchronously and in parallel evaluate each action; and
wait until at least one action evaluation has finished.

18. The computer-implemented system of claim 17, comprising:
exiting if the AwChI is empty or i>d.

19. The computer-implemented system of claim 18, comprising:
collecting, as collected results, all still uncollected results of finished action evaluations.

20. The computer-implemented system of claim 19, comprising:
determining, for each result of the collected results, a set of actions in the set of all actions that use the result as an input.

21. The computer-implemented system of claim 20, comprising:
performing a UNION of all sets of actions that use the collected results as input with the set of all actions; and
increment i by 1.
